(19) United States
(12) Patent Application Publication
(10) Pub. No.: US 2015/0375877 A1
(43) Pub. Date: Dec. 31, 2015

(54) METHOD AND DEVICE FOR PRODUCING BLANKS FOR COLLARS OF PACKETS FOR CIGARETTES

(71) Applicant: FOCKE & CO. (GMBH & CO. KG), Verden (DE)

(72) Inventors: Martin Stiller, Verden (DE); Corvyn Sommer, Verden (DE); Christoph Schneider, Bremen (DE)

(73) Assignee: FOCKE & CO. (GMBH & CO. KG), Verden (DE)

(21) Appl. No.: 14/764,474

(22) PCT Filed: Jan. 16, 2014
(86) PCT No.: PCT/EP2014/000104

§ 371 Date: Jul. 29, 2015

(30) Foreign Application Priority Data
Feb. 5, 2013 (DE) 102013101118.7

(51) Int. Cl. B65B 19/22; B65D 85/10; B31B 1/16; A24F 15/00; B65B 61/02; B65B 61/08

(52) U.S. Cl. CPC B65B 19/228; B65B 61/025; B65B 61/08; B31B 1/16; A24F 15/00; B65D 85/1036; B31B 2241/003; B31B 2201/88

(57) ABSTRACT

A method and a device for producing collars (14) of packets (10) for cigarettes, a preferably continuous material web (23) formed of a packaging material for the collars (14) being conveyed along a transport path (collar path 36), one or more processing stations for processing the material web (23) with regard to one or more characteristic properties of the collars (14) being arranged along the transport path, and the collars (14) being severed from the material web (23) in a processing station by applying a transversely directed severing cut. The material web (23) for the collars (14) is processed in the processing station or processing stations in such a way that at least some collars (14) differ with regard to at least one characteristic property.

### STATEMENT OF RELATED APPLICATIONS

The application is the US National Phase of International Application No. PCT/EP2014/000104 having an International Filing Date of 16 Jan. 2014, which claims priority on German Patent Application No. 102013101118.7 having a filing date of 5 Feb. 2013.

### BACKGROUND OF THE INVENTION

1. Technical Field

The invention relates to a method for producing collars of packets for cigarettes, a preferably continuous material web formed of a packaging material for the collars being conveyed along a transport path, one or more processing stations for processing the material web with regard to one or more characteristic properties of the collars being arranged along the transport path, and the collars being severed from the material web in a processing station by applying a transversely directed severing cut. The invention also relates to a corresponding device for producing collars of packets for cigarettes, a preferably continuous material web formed of a packaging material for the collars being conveyable along a transport path, one or more processing stations for processing the material web with regard to one or more characteristic properties of the collars being arranged along the transport path, and the collars being severable from the material web in a processing station by applying a transversely directed severing cut.

2. Prior Art

The collars discussed here are a conventional element of cigarette packets. In the case of packets of the hinge-lid type, a blank that is arranged on the inner side of the carton part of a cigarette packet and that protrudes from the upwardly open carton part is referred to as a collar. In the closed position of the carton part the collar is covered by the lid, which is mounted pivotably on the carton part. A recess in the region of a collar upper edge is characteristic and facilitates the removal of cigarettes from the packet. Since the collars are detached as far as possible in a waste-free manner from a continuous material web, the collar has a protrusion corresponding to the recess and arranged in the region of a collar lower edge. The collars each usually have three side walls, specifically a collar front wall, which usually has a recess and protrusion, and also two collar side walls arranged on either side of the collar front wall. The walls of the collar are usually secured on the inner side to corresponding walls of the carton part, preferably by bonding.

In methods and devices known from practice collars of this type are usually detached from a continuous material web. This is often performed by means of a knife cylinder, which has a plurality of knives over the circumference and applies the transversely directed severing cuts to the material web in order to sever a collar from the material web. Such a knife cylinder is known for example from DE 10 2004 037 433 A1.

### BRIEF SUMMARY OF THE INVENTION

On this basis, the object of the invention is to further develop methods and devices of the type mentioned in the introduction.

A method for achieving the object mentioned in the introduction is a method for producing collars of packets for cigarettes, a preferably continuous material web formed of a packaging material for the collars being conveyed along a transport path (collar path), one or more processing stations for processing the material web with regard to one or more characteristic properties of the collars being arranged along the transport path, and the collars being severed from the material web in a processing station by applying a transversely directed severing cut, characterized in that the material web for the collars is processed in the processing station or processing stations in such a way that at least some collars differ with regard to at least one characteristic property. Thus, the material web for the collars is processed in the processing station or processing stations in such a way that at least some collars differ with regard to at least one characteristic property.

The collars may be processed differently in the processing station or processing stations with regard to one or more of the following characteristic properties:

shape,

imprint,

embossing,

smell.

With regard to the shape of the collars it may be that the collars are detached from the material web in such a way that in the case of at least some collars the contour of a collar edge differs in the region of the severing cut as characteristic property.

In accordance with a preferred embodiment of the invention it may be that the collars are detached successively from the material web by means of a knife cylinder, on the circumference of which knives distanced from one another are arranged for severing collars from the material web, the contours of the knives of the knife cylinder differing from one another at least in part, such that a number of collars corresponding to the number of knives are severed from the material web during a revolution of the knife cylinder, the contour of the collar edges of the collars differing in accordance with the different knives.

The severing cuts do not necessarily have to be produced by means of a knife cylinder; the use of a plurality of different knives is also conceivable, each of which detaches a different collar from the material web. The knives can be arranged on one or more movable parts, for example in the manner of a punch.

In accordance with a further detail it may be that the collar edges match in portions, such that the collars, which differ at least partially with regard to the collar edge, are conveyed after the separation from the material web by the same pusher in constant alignment, the pusher, in particular a contour of the pusher, bearing against the collar edges in the region of the matching portions.

In accordance with a preferred embodiment the collar edges match in the region of a recess in the region of a collar upper side and/or in the region of shoulders on either side of the recess.

In accordance with another development it may be that the material web is subjected in a processing station to an embossing treatment, an embossing cylinder preferably being used, which during a revolution provides at least one collar with an embossing as characteristic property, which embossing deviates from embossings of at least one other collar.

As already mentioned with regard to the knife cylinder, the embossing elements do not have to be part of an embossing cylinder either.

In accordance with another development it may be that a fragrance, in particular in the form of one or more aroma capsules, is applied to the collars in a processing station, a fragrance being applied at least to one collar from a series of collars processed in succession, said fragrance being different from the fragrance applied to at least one of the other collars. Alternatively the fragrance may also be applied to the material web already during production or in an intermediate step following production and prior to processing.

In accordance with another development it may be that the material web has differently colored and/or printed portions, from which the collars are detached accordingly, such that at least some collars have a color different from other collars or have regions that are colored and/or printed differently.

A further detail may lie in the fact that the collars are processed in the processing stations in such a way that the collars are provided, in a region protruding from a carton part of a packet, with at least one characteristic property, which differs from the characteristic properties of other collars.

A device for achieving the object mentioned in the introduction is a device for producing collars of packets for cigarettes, a preferably continuous material web formed of a packaging material for the collars being conveyable along a transport path (collar path), one or more processing stations for processing the material web with regard to one or more characteristic properties of the collars being arranged along the transport path, and the collars being severable from the material web in a processing station by applying a transversely directed severing cut, characterized in that the material web for the collars can be processed in the processing station or processing stations in such a way that at least some collars differ with regard to at least one characteristic property. The material web for the collars can therefore be processed in the processing station or processing stations in such a way that at least some collars differ with regard to at least one characteristic property.

In accordance with a preferred development a knife cylinder is provided in a processing station, on the circumference of which knife cylinder knives distanced from one another for severing collars from the material web are arranged, the contour of the knives of the knife cylinder differing from one another at least in part, such that a number of collars corresponding to the number of knives can be severed from the material web during a revolution of the knife cylinder, the shape of the collar edges of the collars differing in accordance with the different knives.

In accordance with a preferred development the collars severed from the material web can each be introduced, together with a packet content for a cigarette packet by means of a pusher into a respective pocket of a folding revolver, the pusher bearing in the region of the collar edges, specifically in the region of a matching portion of the collar edges of the collars differing in the remainder at least in part.

In accordance with a preferred development an embossing cylinder for embossing the material web is provided in a processing station, the embossing cylinder providing at least one collar with an embossing as characteristic property during a revolution, which embossing deviates from embossings of at least one other collar.

A material web for achieving the object mentioned in the introduction is a material web for producing collars of packets for cigarettes, a preferably continuous material web formed of a packaging material being provided at intervals with print marks, which serve to control the separation of collars from the material web, characterized in that the material web for the collars is provided with imprints and/or fragrances in such a way that at least some of the collars detached from the material web differ with regard to at least one characteristic property.

### BRIEF DESCRIPTION OF THE DRAWINGS

Preferred exemplary embodiments of the invention will be described hereinafter on the basis of the drawing, in which:

FIG. 1 shows a first exemplary embodiment of a packet for cigarettes of the hinge-lid type with opened lid in spatial representation,

FIG. 2 shows a second exemplary embodiment in an illustration according to FIG. 1,

FIGS. 3 and 4 show two material webs for producing collars in different variants,

FIG. 5 shows part of a packaging machine for cigarettes in spatial representation,

FIG. 6 shows a plan view of part of the packaging machine according to arrow VI in FIG. 5,

FIGS. 7 and 8 show a plan view of the packaging machine in the region of the handling of collars, and

FIG. 9 shows a vertical section through the device in the region of the handling of the collars.

### DETAILED DESCRIPTION OF PREFERRED EMBODIMENTS

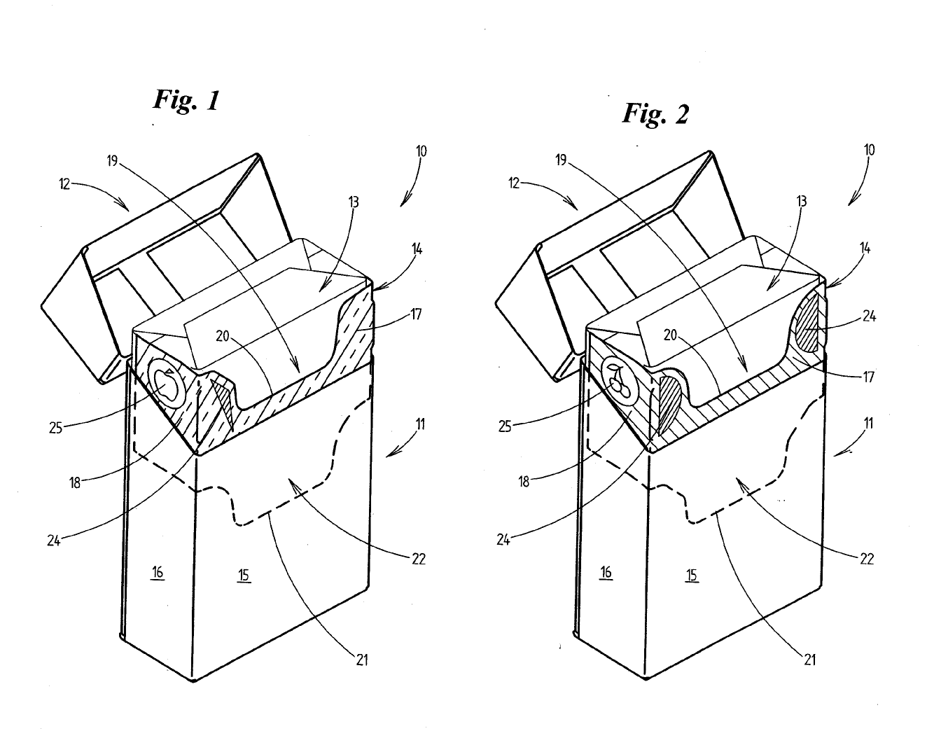

The invention will be explained hereinafter on the basis of a packet 10 for cigarettes. The packet 10 in the shown exemplary embodiments is a packet 10 of the hinge-lid type. This consists of a carton part 11 and a lid 12 mounted on the carton part 11 in a hinged manner. By pivoting the lid 12 (FIGS. 1 and 2), the packet 10 can be opened. The consumer then has access to the packet content, specifically the cigarette block 13.

A key further component of the packet 10, which is of particular importance for the present invention, is a collar 14. The collar is arranged on the inner side of the carton part 11, as is usual, such that it protrudes in part from the carton part. The collar 14 extends in the present case along a front wall of the carton part and also along two narrow side walls 16 each adjacent to the front wall. The collar 14 accordingly has a collar front wall 17 and two lateral collar side walls 18.

The collar 14 has a recess 19 centrally in the region of the collar front wall 17. A collar upper edge 20 is contoured by the recess 19. An opposite collar lower edge 21 is contoured accordingly with a protrusion 22 corresponding to the recess 19.

The shapes of the contour of the collar upper edge 20 and also of the collar lower edge 21 generally match. This results from the production of the collars 14, which are preferably detached in a waste-free manner from a continuous material web. Here, the contour of a collar lower edge 21 of a first collar 14 corresponds to the contour of the collar upper edge 20 of the successive collar 14. However, it is also conceivable to shape the collars 14 such that the contour of a collar lower edge 21 of a first collar 14 deviates from the contour of the collar upper edge 20 of the successive collar 14.

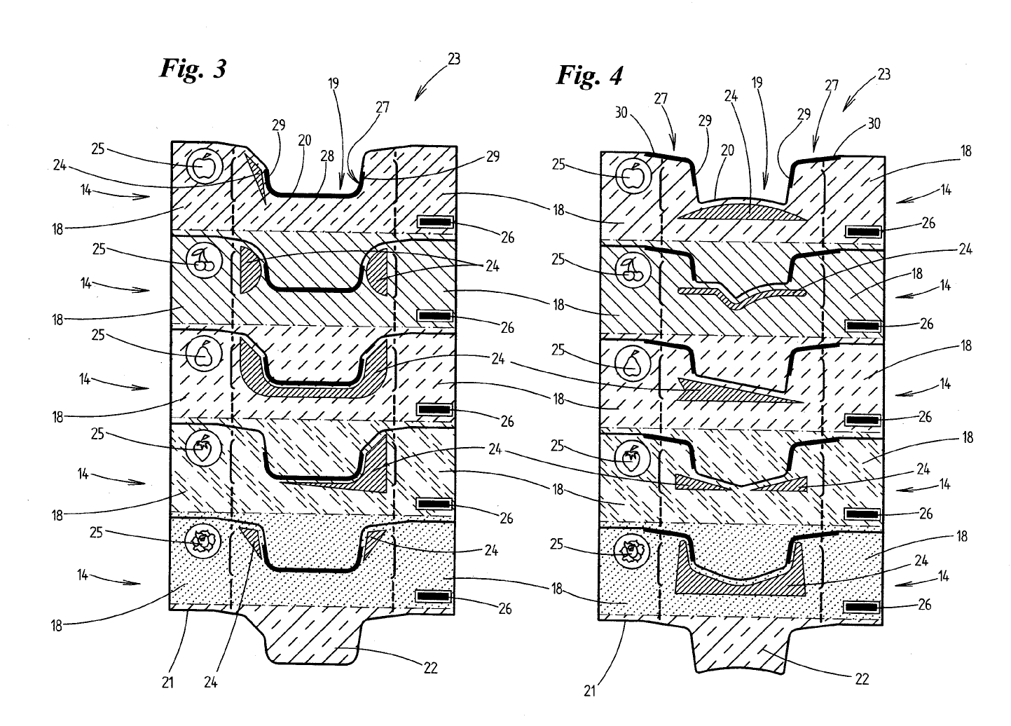

Two different material webs 23 are shown by way of example in FIGS. 3 and 4. It is significant here that each collar 14 differs with regard to one or more characteristic properties from one or more of the other collars 14. The characteristic properties within the scope of this application include the following features:
1. shape of the collar 14 or contour of the collar upper edge 20.
2. imprint of the collar (wide hatching).
3. embossing 24 of the collar 14 (narrow hatching).
4. smell of the collar 14 or applied fragrance 25 (symbol).

In both exemplary embodiments the successive collars 14 within a material web 23 differ in each case with regard to all characteristic features. However, it is also conceivable that the collars 14 differ only with regard to one or more characteristic properties. It is also conceivable that only one collar 14 differs from at least one other collar 14 with regard to a characteristic property.

Both the embossings 24 and the fragrances 25 are applied such that they can be grasped or felt or are to be smelled or activated when the lid 12 is open. Accordingly, the characteristic properties are arranged on the collar 14 in such a way that they are positioned above the closing edge of the carton part 11. An activation of the fragrances by a movement of the lid 12 relative to the carton part 11 is also conceivable, an inner side of a lid wall activating the fragrances by friction.

Outside the visible region, each collar 14 also carries a print mark 26. The different processing steps to which the collars 14 or the material web 23 are/is subjected or controlled with the aid of the print mark 26. Merely the imprint is generally already applied and is not applied only once on site within the packaging machine. However, it is quite conceivable to also apply the imprint on site. The imprint also does not have to be provided over the entire area as in the shown exemplary embodiments, but can be provided only in partial regions. In particular, printing on site during processing is considered in such cases.

The different embossings 24 are purely exemplary and do not in any way constitute a limiting selection. It is thus conceivable that the embossings 24 are applied asymmetrically on the respective collar 14 or by way of example on either side of the recess 19, running around the recess 19 on either side, or only on one side of the recess 19 and below the recess 19.

The form of the collar upper edge 20 or the collar lower edge 21 is also purely exemplary and is not presented conclusively. In this regard other variants are conceivable in addition to the courses extending in a straight line, curved manner, angled manner, etc.

It is also possible that the individual characteristic properties supplement each other, such as the imprint, which may support the embossing 24. Furthermore, it is also conceivable that the embossing 24 supports the contour of the collar 14.

Besides the described characteristic properties, further features are also conceivable as characteristic properties, such as, in particular, atypical punch-outs in the collar 14 or other features that can be grasped by the user.

A key detail of both exemplary embodiments is based on the fact that all collars 14 within a material web 23 have matching portions 27 or partial contours.

In FIGS. 3 and 4 these portions 27 are characterized by a wider line in bold.

In the exemplary embodiment according to FIG. 3 the matching portion 27 is located centrally, in the region of the recess 19, specifically in the region of a base 28 of the recess 19 and also on each side partially along flanks 29 of the recess 19.

In the exemplary embodiment according to FIG. 4 the portion 27 is located on each side of the recess 19 in the region of shoulders 30 of the collar 14, specifically in the upper region of the flanks 29 and adjoining the flanks in a portion of the collar upper edge 20.

For the most efficient production possible of the collars 14, which differ at least in part, it is necessary that each collar 14 within the material web 23 is substantially identical with regard to the matching portions of the collar upper edge 20. The reason for this will become clear under consideration of the structure presented hereinafter of a packaging machine that is conventional with regard to the handling of the collar 14.

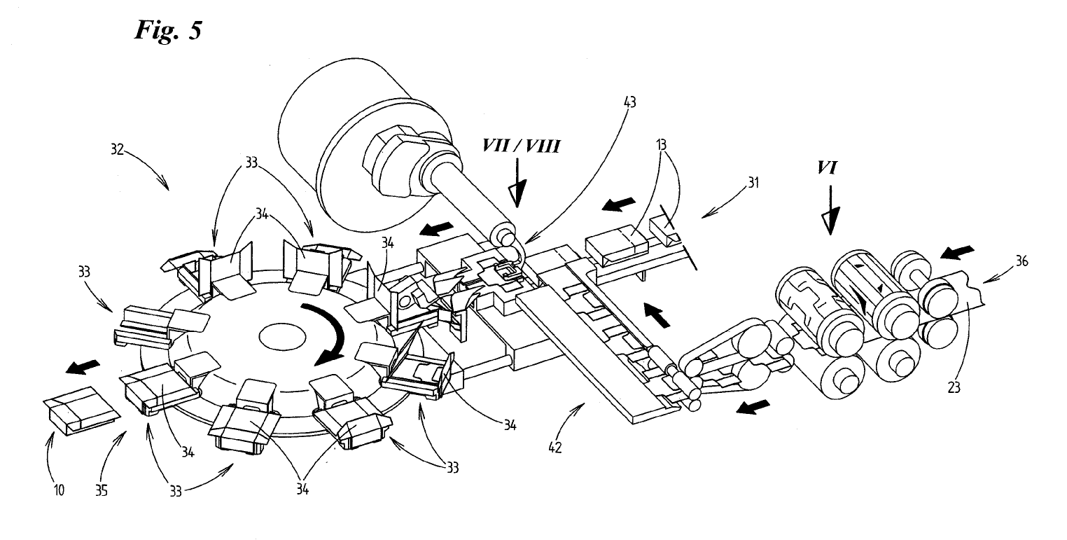

FIG. 5 shows a detail of a packaging machine for cigarettes. Here, cigarette blocks 13 are conveyed along a cigarette path 31 and are fed in each case together with a collar 14 to a folding revolver 32. The folding revolver 32 has pockets 33, in each of which blanks 34, which are already folded in part, for the packets 10 are located at the moment at which the cigarette blocks 13 with collar 14 are fed. Once a cigarette block 13 with collar 14 has been inserted, the folding revolver 32 moves on further, intermittently, folding tabs of the blank 34 being folded over the further path along the folding revolver 32. The substantially finished, folded packets 10 are discharged in a discharge station 35 and are transported further. Here, merely folding tabs of the blank 34 in the region of narrow side walls 16 protrude unfolded. These are then glued and placed against the packet 10 and are connected to further folding tabs to form side walls 16.

In order to feed the collars 14 to the cigarette blocks 13, a collar path 36 is provided in a first region or portion, along which collar path the material web 23 is conveyed. This occurs in the present case by means of a pair of feed cylinders 37.

The feed cylinders 37 are followed by an embossing cylinder 38, which provides the material web 23 with embossings 24 in cooperation with a mating cylinder. The embossing cylinder 38 constitutes a first processing station.

The embossed cylinder 38 is followed by a knife cylinder 39, which severs individual collars 14 from the material web 23 by transversely directed severing cuts. The knife cylinder 39 constitutes a second processing station. The knife cylinder 39 also cooperates with a mating cylinder.

Alternatively to the use of a knife cylinder 39, the use of a punch is also conceivable in order to sever the collars 14 from the material web 23. Such a solution is shown for example in DE 10 2008 026 450 A1. The embossings 24 could also be applied to the material web 23 with a similar solution. The use of embossing cylinders 38 and knife cylinders 39 therefore is not absolutely necessary.

The knife cylinder 23 is followed by a pair of acceleration cylinders 40, which ensure that the severed collars 14 are distanced from one another and are therefore separated.

The acceleration cylinders 40 are followed by a belt conveyor 41, between the conveying idlers of which the separated collars 14 are transported at a distance from one another until the collar path 36 branches transversely. In an angled, second conveying portion 42, the collars 14 are pushed off transversely and transported into a position above the cigarette block 13. From this position, they are inserted together with the cigarette block 13 by means of a pusher 43 into a pocket 33 of the folding revolver 32.

It goes without saying that further processing stations may be provided along the collar path 36, for example processing stations for applying fragrances 25, for forming punch-outs, or for carrying out other processing steps on the material web 23. Merely by way of example, a variant is shown in the present exemplary embodiment in which merely embossings 24 and punch-outs of the blanks are performed in order to separate the collars 14 from the material web 23.

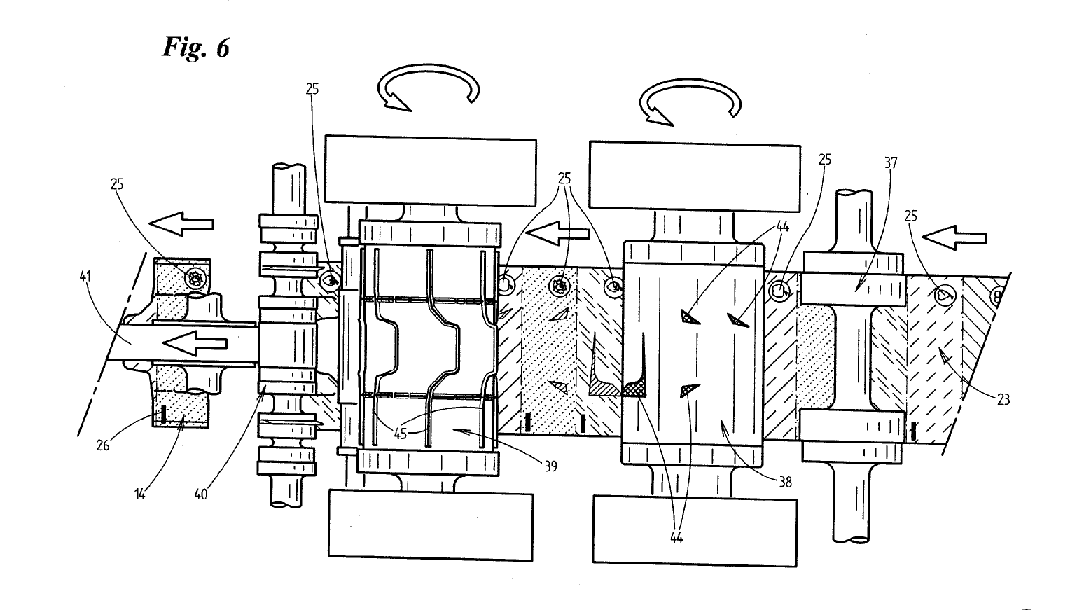

FIG. 6 shows a plan view of the processing stations. Here, it can be seen that the embossing cylinder 38 and the knife cylinder 39 are equipped with different embossing elements 44 and knives 45 respectively. These are arranged, preferably in a stationary manner, in accordance with the collars 14 to be produced. In this case the embossing cylinder 38 and/or the knife cylinder 39 has/have to be replaced in order to produce a material web 23 of different design.

The contour of the knife 45 is preferably such that this extends in a divergent manner in the transport direction along the collar path 36 in accordance with the severing cut. It has been found that such a divergent course of the knife 45 or of the severing cut is advantageous in the case of the subsequent separation of the collars 14.

An arrangement of replaceable embossing elements 44 and knives 45 on the embossing cylinder 38 and knife cylinder 39 respectively is also conceivable.

The processing stations are controlled on the basis of the print mark 26 pre-printed on or applied to the material web 23.

It can also be seen from FIG. 6 that the imprint and fragrances 25 are already applied to the material web 23. However, as already discussed, further processing stations may also be provided for this purpose.

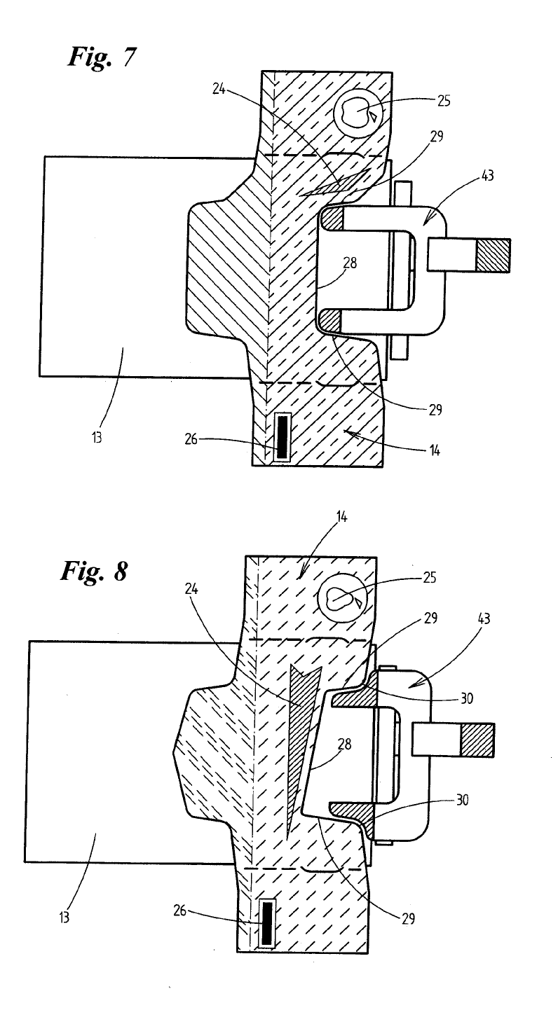

As described in the introduction, all collars 14 of a material web 23 have matching portions 27 in the region of the collar upper edge 20. A key detail lies herein, which will be explained hereinafter with reference to FIGS. 7 to 9.

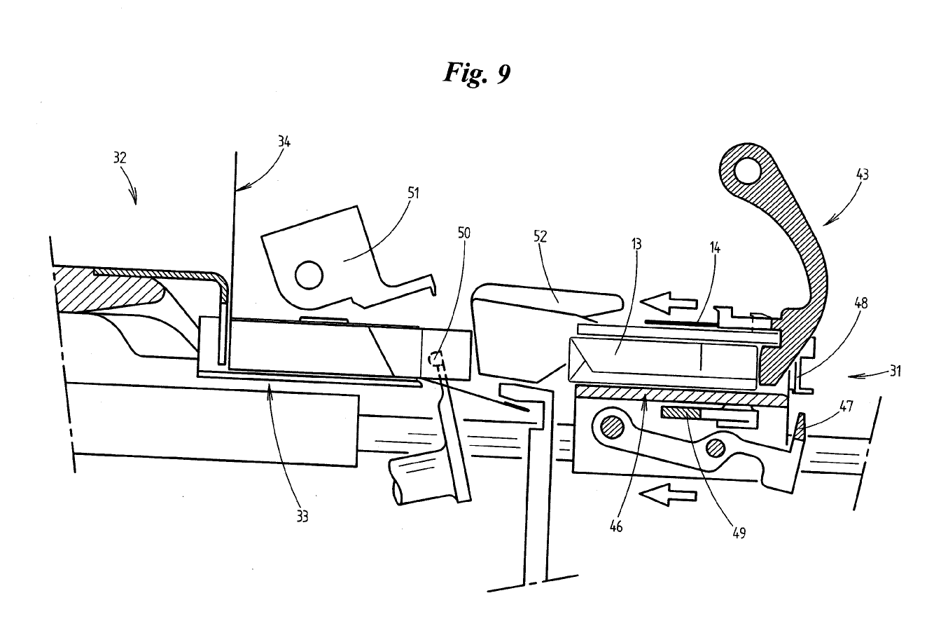

FIG. 9 shows a vertical section through the cigarette path 31 in the region of the pusher 43 or a pocket 33 of the folding revolver 32. Here, it can be seen that the pusher 43 bears on the one hand against a collar 14 and on the other hand against an end face of a cigarette block 13. Here, the cigarette block 13 rests on a folding platform 46, which is moved back and forth between a station for feeding the cigarette block 13 and the collar 14 and a position for transferring same into a pocket 33 of the folding revolver 32. Furthermore, the cigarette block 13 and the collar 14 are processed during the journey into the pocket 33 by a lower folder 48 and a side folder 48 and respectively collar folding switches 52. A control lever 49 for the side folder 48 can also be seen in addition below the folding platform 46. Further elements deal with the folding of the blank 34 in a pocket 33, specifically a rear corner tab folder 50 and a holder 51.

FIGS. 7 and 8 show a plan view of this part of the device in the region of the pusher 43. Here, it can be seen that the part of the pusher 43 bearing against the collar 14 bears in each of the two exemplary embodiments in the region of the collar upper edge 20, more specifically in each case in the region in which the collars 14 within the material web 23 have the matching portions 27.

In FIG. 7 this is the base 28 and the two adjacent flanks 29 of the recess 19. In the exemplary embodiment according to FIG. 8 the matching portions 27 by contrast are the two flanks 29 and the adjoining shoulders 32 on either side of the recess 19.

In this way it is ensured that the collars 14 are conveyed by the pusher 43, independently of the shape of the recess 19 and additionally with stable or accurate positioning, together with the cigarette block 13 in the direction of the pocket 33 of the folding revolver 32. Here, the collars 14 are transported by the pusher 43 such that this bears in two axes or directions against the collar 14 or the collar upper edge 20, such that a tilting of the collars 14 during transport is avoided.

### LIST OF REFERENCE SIGNS

10 packet

11 carton part

12 lid

13 cigarette block

14 collar

15 front wall (carton part)

16 side wall (carton part)

17 collar front wall

18 collar side wall

19 recess

20 collar upper edge

21 collar lower edge

22 protrusion

23 material web

24 embossing

25 fragrance

26 print mark

27 matching portion

28 base

29 flank

30 shoulder

31 cigarette path

32 folding revolver

33 pocket

34 blank

35 discharge station

36 collar path

37 feed cylinder

38 embossing cylinder

39 knife cylinder

40 acceleration cylinder

41 belt conveyor

42 conveying portion

43 pusher

44 embossing element

45 knife

46 folding platform

47 lower folder

48 side folder

49 control lever

50 corner tab folder

51 holder

52 collar folding switch

What is claimed is:

1. A method for producing collars (14) of packets (10) for cigarettes, comprising:
conveying a preferably continuous material web (23) formed of a packaging material for the collars (14) along a transport path (collar path 36);
arranging at least one processing station for processing the material web (23) with regard to at least one characteristic property of the collars (14) arranged along the transport path; and
severing the collars (14) from the material web (23) in a processing station by applying a transversely directed severing cut,
wherein the material web (23) for the collars (14) is processed in the processing station or processing stations in such a way that at least some collars (14) differ with regard to at least one characteristic property.

2. The method according to claim 1, wherein the collars (14) are processed differently in the processing station or the processing stations with regard to one or more of the following characteristic properties:
shape,
imprint,
embossing (24),
smell.

3. The method according to claim 1, wherein the collars (14) are detached from the material web (23) in such a way that in the case of at least some collars (14) the contour of a collar edge (20) differs in the region of the severing cut as characteristic property.

4. The method according to claim 3, wherein the collars (14) are detached successively from the material web (23) by means of a knife cylinder (39), on the circumference of which knives (45) distanced from one another are arranged for severing collars (14) from the material web (23), the contours of the knives (45) of the knife cylinder (39) differing from one another at least in part, such that a number of collars (14) corresponding to the number of knives (45) are severed from the material web (23) during a revolution of the knife cylinder (39), the contour of the collar edges (20) of the collars (14) differing in accordance with the different knives (25).

5. the method according to claim 3, wherein the collars (14) are detached from the material web (23) by means of knives (45), at least some knives (45) differing at least in part with regard to the contour.

6. The method according to claim 3, wherein the collar edges (20) match in portions, such that the collars (14), which differ at least partially with regard to the collar edge (20), are conveyed after the separation from the material web (23) by the same pusher (43) in constant alignment, the pusher (43), in particular a contour of the pusher (43), bearing against the collar edges (20) in the region of the matching portions (27) in each case.

7. The method according to claim 6, wherein the collar edges (20) match in the region of a recess (19) in the region of a collar upper side (20) and/or in the region of shoulders (30) on either side of the recess (27).

8. The method according to claim 1, wherein the material web (23) is subjected in a processing station to an embossing treatment, an embossing cylinder (38) being used, which during a revolution provides at least one collar (14) with an embossing (24) as characteristic property, which embossing deviates from embossings (24) of at least one other collar (14).

9. The method according to claim 1, wherein the material web (23) is subjected in a processing station to an embossing treatment, a plurality of embossing means being used, which provide at least one collar (14) with an embossing (24) as characteristic property, which embossing deviates from embossings (24) of at least one other collar (14).

10. The method according to claim 1, wherein the collars (14) are processed in the processing stations in such a way that the collars (14) are provided in a region protruding from a carton part (11) of a packet (10) with at least one characteristic property, which differs from the characteristic properties of other packets (10).

11. A device for producing collars (14) of packets (10) for cigarettes, comprising:
a transport path (36) for conveying a preferably continuous material web (23) formed of a packaging material for the collars (14) along; and
at least one processing station for processing the material web (23) with regard to one or more characteristic properties of the collars (14), the at least one processing station being arranged along the transport path, and the collars (14) being severable from the material web (23) in a processing station by applying a transversely directed severing cut,
wherein the material web (23) for the collars (14) is processed in the processing station or processing stations in such a way that at least some collars (14) differ with regard to at least one characteristic property.

12. The device according to claim 11, further comprising a knife cylinder (39) provided in a processing station, on the circumference of which knife cylinder knives (45) distanced from one another for severing collars (14) from the material web (23) are arranged, the contour of the knives (45) of the knife cylinder (39) differing from one another at least in part, such that a number of collars (14) corresponding to the number of knives (45) can be severed from the material web (23) during a revolution of the knife cylinder (39), the contour of the collar edges (20) of the collars (14) differing in accordance with the different knives (45).

13. The device according to claim 11, further comprising:
a pusher (43);
and a folding revolver (32),
wherein the collars (14) severed from the material web (23) are introduced, together with a packet content for a packet (10), by means of the pusher (43) into a respective pocket (33) of the folding revolver (32), the pusher (43) bearing in the region of the collar edges (20), specifically in the region of a portion (27), which matches in all collars (14), of the collar edges (20) of the collars (14) differing in the remainder at least in part.

14. The device according to claim 11, further comprising an embossing cylinder (38) for embossing the material web (23) is provided in a processing station, the embossing cylinder (38) providing at least one collar (14) with an embossing (24) as characteristic property during a revolution, which embossing deviates from embossings (24) of at least one other collar (14).

15. A material web for producing collars (14) of packets (10) for cigarettes, a preferably continuous material web (23) formed of a packaging material being provided at intervals with print marks (26), which serve to control the separation of collars (14) from the material web (23), wherein the material web (23) for the collars (14) is provided with imprints and/or fragrances (25) in such a way that at least some of the collars (14) detached from the material web (23) differ with regard to at least one characteristic property.
